(19) United States
(12) Patent Application Publication
(10) Pub. No.: US 2009/0119492 A1
(43) Pub. Date: May 7, 2009

(54) Data Processing Apparatus and Method for Handling Procedure Call Instructions

(76) Inventor: David James Seal, Cambridge (GB)

Correspondence Address: NIXON & VANDERHYE P.C., 901 N. Glebe Road, 11th Floor, Arlington, VA, 22203-1808, US

(21) Appl. No.: 11/992,056

(22) PCT Filed: Oct. 26, 2005
(86) PCT No.: PCT/GB2005/004131

§ 371 Date: Mar. 14, 2008

(51) Int. Cl. G06F 9/30

(52) U.S. Cl. 712/233; 712/E09.016

(57) ABSTRACT

A data processing apparatus and method are provided for handling procedure call instructions. The data processing apparatus has processing logic for performing data processing operations specified by program instructions fetched from a sequence of addresses, at least one of the program instructions being a procedure call instruction specifying a branch operation to be performed. Further, a control value is stored within control storage, and the processing logic is operable in response to a control value modifying instruction to modify that control value. If the control value is clear, the processing logic is operable in response to the procedure call instruction to generate a return address value in addition to performing the branch operation, whereas if the control value is set, the processing logic is operable in response to the procedure call instruction to suppress generation of the return address value and to cause the control value to be clear in addition to performing the branch operation. This provides significant flexibility in how procedure call instructions are used within the data processing apparatus.

### FIELD OF THE INVENTION

The present invention relates to the field of data processing systems, and more particularly relates to the handling of procedure call instructions within such data processing systems.

### BACKGROUND OF THE INVENTION

It is known that computer programs often contain sequences of program instructions that are frequently repeated within the computer program. In order to produce a computer program with a smaller code size, it is known to arrange such blocks of computer program instructions into functions or subroutines which can be called from various positions within the computer program. More particularly, a procedure call instruction specifying a branch operation can be used to cause the computer program to branch to such a subroutine.

It is normal for such subroutines to terminate with a return instruction which commands the data processing apparatus to return to the instruction immediately following the point in the computer program from where the call to the subroutine was made. When the block of instructions forming the subroutine is short in length, then the overhead of providing the return instruction at the end of the subroutine can form a significant proportion of the size of the subroutine itself. As an example, if the subroutine block of program instructions being called is only three instructions in length, then the necessary return instruction at the end of the block increases this length to four instructions and results in a significant increase in code size when this is repeated across a large number of such subroutines which may be included within a computer program as a whole.

The subroutine block of instructions may be identified explicitly in the source code or may be identified during compilation. Subroutines identified during compilation are typically likely to be relatively short blocks of instructions.

To alleviate the above described problem, ARM developed a type of procedure call instruction which was referred to as the EMB (Embedded Macro Block) instruction, which would allow a sequence of instructions forming a subroutine (also referred to as the “macro block”) to be called. The EMB instruction included an offset field and a length field, the offset field specifying the location of the macro block in terms of an offset from the EMB instruction (i.e. using normal program counter (PC) relative branch addressing), whilst the length field identified the length of the macro block. At the end of the macro block, the processor would return to the instruction after the EMB instruction without needing an explicit return instruction.

One proposed implementation for the EMB instruction was described in GB-A-2,400,198. In accordance with the technique described therein, when the EMB instruction is used the PC value associated with each instruction in the macro block is the same as the PC value associated with the EMB instruction, and additionally a micro-PC value is provided which is incremented for each instruction in the macro block.

Typically, a procedure call instruction will, in addition to performing the required branch operation, specify within a link register (LR) a return address to which execution should return after the subroutine has been executed, this return address typically being set to the address of the instruction immediately after the procedure call instruction. Through use of an explicit micro-PC value, it was possible for the macro block to include instructions that changed the LR value. However, it was found that macro block instructions that used the PC value may not operate as expected. Further, if an interrupt occurred whilst part way through execution of the macro block, then on completion of the exception handling routine triggered by that interrupt, it proved quite cumbersome to return to the correct part of the macro block. In particular, this required re-execution of the EMB instruction, along with modification of the macro block's micro-PC value so as to start execution at the micro-PC value existing at the time the interrupt occurred.

From the above discussion, it will be appreciated that whilst the EMB instruction enabled a code size reduction, it introduced complexities elsewhere which are generally undesirable.

### SUMMARY OF THE INVENTION

Viewed from a first aspect, the present invention provides a data processing apparatus, comprising: processing logic operable to perform data processing operations specified by program instructions fetched from a sequence of addresses, at least one of the program instructions being a procedure call instruction specifying a branch operation to be performed; control storage operable to store a control value; the processing logic being operable in response to a control value modifying instruction to modify the control value; if the control value is clear, the processing logic being operable in response to the procedure call instruction to generate a return address value in addition to performing the branch operation; if the control value is set, the processing logic being operable in response to the procedure call instruction to suppress generation of the return address value and to cause the control value to be cleared in addition to performing the branch operation.

In accordance with the present invention, a control value is provided which can be modified by a control value modifying instruction. This control value is then used to modify the behaviour of a procedure call instruction. More particularly, if the control value is clear, the processing logic is operable in response to a procedure call instruction to generate a return address value in addition to performing the branch operation, and hence it can be seen that when the control value is clear the behaviour of the procedure call instruction is entirely normal. However, if the control value is set, the processing logic is operable in response to the procedure call instruction to suppress generation of the return address value and to cause the control value to be cleared in addition to performing the branch operation. Hence, when the control value is set, the procedure call instruction performs the required branch operation but does not generate a return address value. Further, the occurrence of the procedure call instruction causes the control value to be cleared, so that the setting of the control value by the control value modifying instruction only affects the behaviour of the first procedure call instruction following that control value modifying instruction.

It has been found that this approach of the present invention provides a great deal of flexibility in the use of procedure call instructions. In particular, when the control value is set, it enables the procedure call instruction to execute without overwriting a return address value that may previously have been created by a preceding instruction. Hence, when the subroutine performed as a result of the procedure call instruction has completed, the execution of the program can return to a return address value specified by something other than the procedure call instruction that performed the branch operation to that subroutine.

The control value modifying instruction may be used solely to modify the control value. However, in one embodiment, the processing logic is further operable in response to the control value modifying instruction to generate a return address value. Hence, it can be seen that in such embodiments, when the control value modifying instruction sets the control value, then the next procedure call instruction encountered thereafter will perform a branch operation without generating a return address value. Thus, on completion of the subroutine executed as a result of that branch operation, execution of the program will return to the return address value generated by the control value modifying instruction. This functionality hence enables the return address generating functionality of a procedure call instruction to be selectively suppressed so as to selectively enable a return address generated by the control value modifying instruction to be used on completion of the subroutine specified by the procedure call instruction. This provides significantly improved flexibility with regard to the manner in which procedure call instructions can be used to achieve code size reductions in computer programs.

The control value modifying instruction can take a variety of forms. However, in one embodiment, the control value modifying instruction is itself a procedure call instruction and hence further specifies a branch operation to be performed. Accordingly, in such embodiments, the control value modifying instruction acts in the same way as the above described procedure call instruction, but with the additional feature of setting the control value. It has been found that such a control value modifying instruction provides a limited version of the earlier-described EMB instruction's ability to replace a code sequence by a “call” to another, identical code sequence (also referred to herein as the macro block). In particular, it has been found that the control value modifying instruction can perform the same function as the earlier described EMB instruction in situations where the macro block ends with a procedure call instruction. Further, the control value modifying instruction is significantly simplified with respect to the earlier described EMB instruction, since it does not need to specify a length of the macro block being branched to, and there is no need for a micro-PC value to be maintained.

In one embodiment, the control value modifying instruction comprises an offset field specifying a target address for the branch operation relative to an address of the control value modifying instruction. Hence, in one embodiment, such an approach enables the control value modifying instruction to use a standard “PC+signed immediate offset” addressing mode for determining the target address for the branch operation. In one embodiment, the value of the offset field could be constrained to always specify a positive offset. However, in one particular embodiment, the offset field specifies a negative offset value such that the target address is an address less than the address of the control value modifying instruction. This has the advantage that when a compiler is generating code, then by the time the control value modifying instruction is generated, the macro block to be called from that instruction is always in already-generated code, making the process of identifying that macro block relatively easy.

The processing logic can take a variety of forms. In one embodiment, the processing logic comprises: instruction fetching logic operable to fetch the program instructions from the sequence of addresses; instruction decode logic responsive to the program instructions fetched by said instruction fetching logic to control the data processing operations specified by said program instructions; and execution logic operable under control of said instruction decode logic to execute said data processing operations. In one particular embodiment, the processing logic can be formed in a pipelined manner, with each of the instruction fetching logic, instruction decode logic and execution logic occupying one or more pipeline stages.

In one embodiment, the instruction fetching logic is operable, upon fetching a control value modifying instruction, to modify the control value. Hence, once the instruction has been received by the instruction fetching logic, the control value is modified.

In one embodiment, if the control value is set prior to handling of the procedure call instruction by the processing logic, the instruction decode logic is operable in response to the procedure call instruction to suppress generation of the return address value. In such embodiments, the instruction fetching logic will typically pass to the instruction decode logic the control value as it was prior to the receipt of the procedure call instruction. This is important as the procedure call instruction will cause the control value, if set, to be cleared. The instruction decode logic can then use the value of the control value passed to it by the instruction fetching logic in order to determine whether generation of the return address value should be suppressed.

In one embodiment, if the control value is set prior to handling of the procedure call instruction by the processing logic, the instruction fetching logic is operable in response to the procedure call instruction to cause the control value to be cleared. Again, the instruction fetching logic will typically pass to the instruction decode logic the value of the control value prior to it being cleared, and hence the instruction decode logic will respond to the set control value to ensure suppression of the generation of the return address value by the procedure call instruction.

As described earlier, where the control value modifying instruction is itself a procedure call instruction, this enables the control value modifying instruction to replicate the function of the earlier-described EMB instruction in situations where the macro block branched to by the control value modifying instruction ends with a procedure call instruction. However, in one embodiment, it has been found that such a control value modifying instruction can still replicate the function of the earlier-described EMB instruction even if the macro block does not end with a procedure call instruction, through the provision of a further instruction that can be added at the end of the macro block. More particularly, in one embodiment, this additional instruction takes the form of a selective return instruction. In one embodiment, if the control value is clear the processing logic is operable in response to the selective return instruction to perform no operation, and if the control value is set the processing logic is operable in response to the selective return instruction to perform a return operation to branch to an instruction at the return address value and to cause the control value to be cleared.

Hence, if a macro block is called by a control value modifying instruction, resulting in the control value being set, then the placing of such a selective return instruction at the end of the macro block will ensure that the macro block will return to the instruction following the control value modifying instruction even if that macro block does not end with a procedure call instruction. Similarly, if that macro block is not called by a control value modifying instruction, and hence the control value is not set, then the presence of this selective return instruction has no effect, and in that instance no operation is performed by that selective return instruction. Hence, the use of the selective return instruction can further increase the number of scenarios in which the control value modifying instruction can be used to achieve code density improvements.

Viewed from a second aspect, the present invention provides a method of operating a data processing apparatus having processing logic for performing data processing operations specified by program instructions fetched from a sequence of addresses, at least one of the program instructions being a procedure call instruction specifying a branch operation to be performed, the method comprising using the processing logic to perform the steps of: storing a control value; in response to a control value modifying instruction, modifying the control value; if the control value is clear, in response to the procedure call instruction, generating a return address value in addition to performing the branch operation; and if the control value is set, in response to the procedure call instruction, suppressing generation of the return address value and causing the control value to be cleared in addition to performing the branch operation.

Viewed from a third aspect, the present invention provides a computer program product comprising a computer program operable when executed on a data processing apparatus to cause the data processing apparatus to operate in accordance with the method of the second aspect of the present invention, the computer program comprising at least one procedure call instruction and at least one control value modifying instruction.

### BRIEF DESCRIPTION OF THE DRAWINGS

The present invention will be described further, by way of example only, with reference to an embodiment thereof as illustrated in the accompanying drawings, in which:

FIG. 1 is a block diagram illustrating a data processing apparatus in accordance with one embodiment of the present invention;

FIG. 2 is a flow diagram illustrating the processing performed in one embodiment of the present invention when handling a procedure call instruction;

FIG. 3 is a flow diagram illustrating the processing performed in one embodiment of the present invention when handling a Return from Macro (RFM) instruction;

FIG. 4 is a diagram schematically illustrating the use of the Branch and Link to Macro (BLM) instruction in accordance with one embodiment of the present invention;

FIG. 5 is a diagram schematically illustrating the use of the BLM instruction in combination with the RFM instruction in accordance with one embodiment of the present invention;

FIG. 6 is a diagram schematically illustrating the use of nested BLM instructions in accordance with one embodiment of the present invention; and

FIG. 7 schematically illustrates the architecture of a general purpose computer which may execute a computer program using the above techniques.

### DESCRIPTION OF AN EMBODIMENT

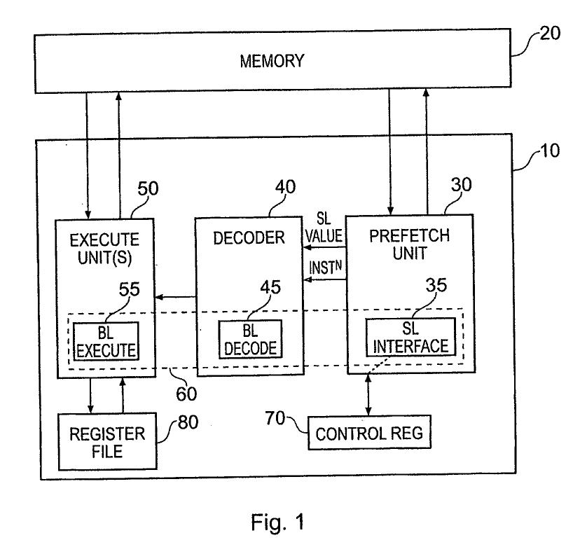

FIG. 1 is a block diagram of a data processing apparatus in accordance with one embodiment of the present invention. The data processing apparatus has a processor core 10 which is coupled to a memory system 20, the memory system 20 containing instructions to be executed by the processor 10 and data used by the processor 10 when executing those instructions. The processor 10 can be considered to comprise a prefetch unit 30, a decode unit 40 and one or more execute units 50, and often these units will be arranged in a pipelined manner. For example, each of the units 30, 40, 50 may comprise one or more pipeline stages. In one embodiment, the prefetch unit 30 and decode unit 40 may be part of a common pipeline, and then separate pipelines may be provided for each of the execute units 50. Hence, for example, an Arithmetic Logic Unit (ALU), a multiplication unit and a Load Store Unit (LSU) may be provided, each forming a separate execute unit, and each having a number of pipeline stages.

The prefetch unit 30 is responsible for prefetching instructions for execution within the data processing apparatus 10, and as is known in the art may include branch prediction logic to predict whether branches will be taken or not taken, with the prefetch unit then prefetching instructions accordingly dependent on that prediction. As the instructions are prefetched by the prefetch unit 30 from the memory 20, they are passed to the decoder 40 which decodes the instructions and then forwards them to the appropriate execute unit 50 for execution. The data processed by the execute unit(s) 50 is held in a register file 80, and the LSU (one of the execute units 50) is responsible for executing load and store instructions in order to load data into the register file 80 from the memory 20, and store data back from the register file 80 to the memory 20 as and when required.

The processor 10 also has one or more control registers 70 for storing various pieces of control data used to control the operation of the processor 10. The control register 70 may in one embodiment consist of a Current Processor Status Register (CPSR) for storing various bits of status data, and additionally the control register 70 may contain a register holding the current PC value. In accordance with one embodiment of the present invention, an extra bit is added to the CPSR register, which will be referred to herein as a “Suppress Link” (SL) bit, and which affects instruction decode performed by the decoder 40. The management of this SL bit is performed by SL interface logic 35 provided within the prefetch unit 30. In particular, in accordance with one embodiment of the present invention, a new instruction referred to herein as a Branch and Link to Macro (BLM) instruction is provided, which has the function of a procedure call instruction, but in addition causes the SL bit to be set. Accordingly, when the prefetch unit 30 prefetches a BLM instruction, the SL interface 35 is arranged to access the control register 70 in order to set the SL bit.

In addition, each time a procedure call instruction (whether a BLM instruction or any other procedure call instruction) is prefetched, then the current value of the SL bit needs to be checked since the behaviour of the procedure call instruction is dependent on the value of the SL bit. More particularly, if the SL bit is not set, then the processor 10 will execute the procedure call instruction in the standard manner, and accordingly a branch operation will be performed to a target address specified by the procedure call instruction, and additionally a return address value will be generated by the procedure call instruction (typically this being the address immediately following the address of that procedure call instruction). However, if the SL bit is set, then this will modify the way in which the processor 10 handles the procedure call instruction, and in particular will cause the generation of the return address value to be suppressed. In addition, in that scenario, the SL interface 35 within the prefetch unit 30 will be arranged to clear the SL bit in the control register 70.

In embodiments of the present invention, as each instruction is passed from the prefetch unit 30 to the decode logic 40, various control bits are also passed to the decode logic from the prefetch unit. For the purposes of describing the embodiment of the present invention, the control bit of interest is the SL bit, and the prefetch unit 30 is arranged in one embodiment to pass to the decode logic 40 with each instruction the value of the SL bit as it was at the time the instruction was handled by the prefetch unit (and in particular as it stands prior to any modification performed by the prefetch unit when processing that instruction). In such an embodiment, the decode logic can be arranged to ignore the SL bit for all instructions other than procedure call instructions. In an alternative embodiment, the prefetch unit 30 can be arranged to only pass the value of the SL bit to the decode logic 40 with each procedure call instruction, in which event that same wire could be used in association with other classes of instruction to pass additional information associated with those instructions.

Within the decoder 40, BL decode logic 45 is provided for decoding any procedure call instructions (these instructions also being referred to herein generically as BL instructions). In particular, the BL decode logic 45 is responsive to the SL value received in association with the instruction to decide whether the return address generation functionality of the procedure call instruction should be suppressed or not. Hence, if the SL value is set, the BL decode logic 45 will suppress generation of the return address, whereas if the SL value is not set, then the BL decode logic 45 will allow the return address value to be generated. The actual generation of the return address value is in one embodiment performed in BL execute logic 55 provided within the execute unit(s) 50.

The instruction as decoded by the decode logic 40 is routed to the appropriate execute unit 50 for execution. For procedure call instructions, these will be routed to the BL execute logic 55 where the appropriate branch operation will be performed. Assuming the branch is taken, the target for the procedure call instruction is in preferred embodiments specified by an offset field within the procedure call instruction which specifies the target address relative to the PC value associated with that procedure call instruction. If the branch is not taken, processing merely proceeds to the instruction following the procedure call instruction (i.e. at the incremented PC value).

As mentioned previously, the prefetch unit 30 may include branch prediction logic which predicts whether the branch specified by the procedure call instruction will be taken, and dependent thereon identifies the address from which further instructions should be prefetched. Accordingly, if the prediction performed by the branch prediction logic within the prefetch unit 30 is correct, then the prefetch unit will have fetched the required instruction to be executed after the procedure call instruction. In the event that the prediction performed by the branch prediction logic of the prefetch unit 30 is incorrect, then as is known in the art any pending instructions will need to be flushed from the pipeline, and the prefetch unit 30 will then prefetch the required instruction from memory 20 in order to enable processing to be resumed. This may for example be the case if the procedure call instruction is conditional, and the BL execute logic 55 determines based on the relevant condition codes that the procedure call instruction should not be executed when the branch prediction unit had predicted that it would be executed, or vice versa.

The SL interface logic 35, BL decode logic 45 and BL execute logic 55 can be considered to form procedure call handling logic 60 within the processor 10. Whilst in FIG. 1 the logic used to set and reset the SL bit is shown in the prefetch unit 30, the BL decode logic 45 used to selectively suppress generation of the return address value dependent on the value of the SL bit is shown in the decode logic 40, and the remaining functionality of the procedure call instruction is shown as being executed within the BL execute logic 55 of the execute unit 50, it will be appreciated that in alternative embodiments these different functions can be performed at different stages within the processor 10 and in particular can be performed in different orders, subject to any dependencies between the operations.

The SL interface 35 can be embodied by a state machine that sets the SL bit whenever a BLM instruction is processed by the prefetch unit, and clears the SL bit whenever a non-BLM procedure call instruction or an RFM instruction are handled by the prefetch unit. Whenever the prefetch unit passes an instruction into the decode logic stage 40, it passes the pre-instruction state of this state machine into the decode stage as well. Any logic that needs to backtrack in the instruction stream because instructions already passed into the decode stage are cancelled (for example to correct a mispredicted branch or because an exception occurred) must also cancel the SL bit effects of those instructions, i.e. basically set the SL state machine back to an earlier state.

Although not shown in FIG. 1, it will be appreciated that, if desired, the SL bit value can be passed from the decode logic 40 to the execute unit 50, along with any other processor status bits desired. This may for example be appropriate to enable the SL bit value to be stored if an interrupt is received, etc.

As with other CPSR bits, the SL bit can be saved to appropriate saved processor status registers (SPSRs) as and when required for the usual purpose of preserving and restoring the CPSR bits before and after exception handling. Accordingly, on an exception entry, the CPSR bits (including the SL bit) will be copied to the relevant SPSR register, and the SL bit in the CPSR register would then be cleared to “insulate” the exception handler from the SL value of the code in which the exception occurred. The exception return instructions would copy the value back as part of their normal restoration of the CPSR value of the code in which the exception occurred.

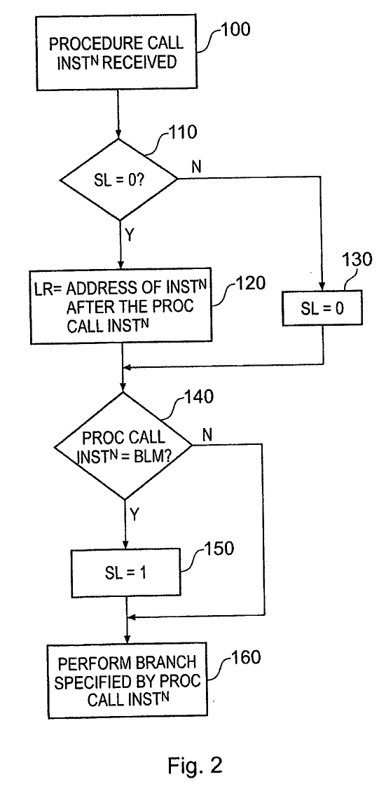

FIG. 2 is a flow diagram illustrating the processing performed by the processor 10 when handling a procedure call instruction. Firstly, at step 100, a procedure call instruction is received by the prefetch unit 30, whereafter at step 110 it is determined whether the SL bit is clear (i.e. not set). In a particular example illustrated in FIG. 2, it is assumed that if the SL bit has a value of zero, it is clear, whilst if it has a value of one it is set, but it will be appreciated that these values could be reversed in alternative embodiments.

If at step 110 it is determined that the SL bit is clear, then at step 120 the return address value is generated by storing within the link register (which typically is one of the registers of the register file 80) the address of the instruction occurring after the procedure call instruction. In practice, this is typically generated by incrementing the current PC value associated with the procedure call instruction by some predetermined amount, this predetermined amount depending on the instruction length.

If at step 110 it is determined that the SL bit is set, then instead the process branches to step 130 where the SL interface 35 is arranged to clear the SL bit in the control register 70.

After either step 120 or step 130, the process then proceeds to step 140, where it is determined whether the procedure call instruction is the BLM instruction. If it is not, then the process proceeds directly to step 160 where the branch operation specified by the procedure call instruction is performed. As discussed earlier with reference to FIG. 1, such performance may involve evaluating any condition codes to determine whether the branch should actually take place or not.

If at step 140 it is determined that the procedure call instruction is a BLM instruction, then the process proceeds to step 150, where the SL interface 35 is arranged to set the SL bit, whereafter the process proceeds to step 160, where the branch operation specified by the procedure call instruction is performed.

Whilst the flow diagram of FIG. 2 sets out the various steps sequentially, it will be appreciated that in some embodiments certain of the steps may be performed in parallel, or the order of certain steps may be altered. Furthermore certain steps can be optimised. As an example, if the SL bit is 1 and the instruction is a BLM instruction, the sequence of operations in FIG. 2 causes the SL bit to be cleared to 0 at step 130, and later set to 1 again at step 150. In one implementation, the process could be adapted such that the SL bit is not changed at all in these circumstances.

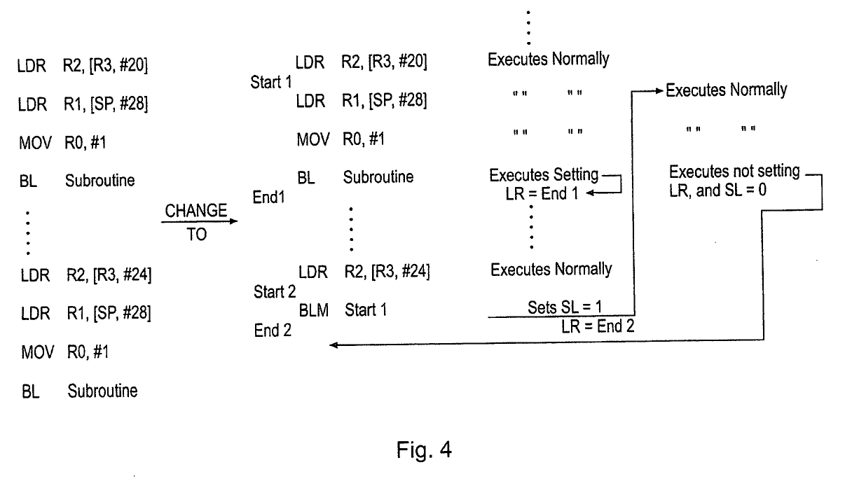

An example as to how the BLM instruction of one embodiment may be used to achieve code density savings is illustrated schematically in FIG. 4. On the left hand side of FIG. 4, a sequence of program instructions is shown, and it can be seen that a block of three instructions comprising a load instruction, a move instruction and a procedure call instruction branching to a subroutine, is repeated within this sequence of instructions. In particular, it can be seen that the final three instructions listed are absolutely identical to the second to fourth instructions listed, in that they include the same source and destination operands. A code density saving can be achieved by re-expressing the sequence of instructions as indicated in the middle part of FIG. 4. The terms “start 1”, “end 1”, “start 2” and “end 2” are merely pointer values used to identify particular locations within the sequence of program instructions. As can be seen, the final three instructions on the left hand side of FIG. 4 are replaced by a single BLM instruction identifying a branch operation to be performed to location “start 1”. As discussed earlier, the location start 1 will typically be identified by an offset value within the BIM instruction identifying an offset relative to the PC value of that BLM instruction.

The way in which these instructions are executed by the processor 10 is illustrated schematically in the right hand side of FIG. 4. In particular, the first two load instructions and the move instruction execute normally. When the BL instruction is then executed, it will be seen with reference to FIG. 2 that since the SL bit is currently clear, the return address value will be generated at step 120 in order to store within the link register a pointer to the location “end 1”, i.e. the address of the instruction immediately following the BL instruction. The branch operation will then be performed in order to execute the required subroutine, and at the end execution will return to the address stored in the link register, i.e. the location “end 1”. When execution later reaches the LDR instruction shown in the lower half of FIG. 4, then this will execute normally, whereafter the BLM instruction will be executed. Again with reference to FIG. 2, it can be seen that since the SL bit is not set, then at step 120 the link register will be updated to reference the location “end 2” and then at step 150 the SL bit will be set to a logic one value. As mentioned earlier, it is not necessary for these two events to occur in that order, and indeed in preferred embodiments the SL bit is updated by the SL interface 35 before the return address value to be stored in the link register is generated later in the pipeline. Nevertheless, the evaluation performed by the BL decode logic 45 to determine whether the return address value should be generated or suppressed will be based on the previous value of the SL bit, and accordingly will be based on a clear value for the SL bit.

The execution of the BLM instruction will then cause instruction flow to branch to the location “start 1”, causing the LDR and MOV instructions to then be executed normally. When the BL instruction is then encountered for the second time, it will be seen with reference to FIG. 2 that because the SL bit is set, the generation of the return address value will be suppressed, and instead at step 130 the SL bit will be cleared. The subroutine specified by the BL instruction will then be performed and at the end the process will branch to the address stored in the link register. However, since the BL instruction did not generate an updated return address value to be stored in the link register, the value in the link register will still refer to the location “end 2”, and accordingly the instruction flow will at this time return to the location “end 2”. Accordingly, it can be seen that through the use of the BLM instruction, six instructions are reduced to four instructions, thereby enabling significant code density improvements to be made. Further, the BLM instruction is significantly simplified with regard to the earlier-described EMB instruction, since there is no need within the BLM instruction to specify any length value for the block of instructions being branched to by the BLM instruction, nor is there any need to set and maintain any micro-PC value. It has been found that instructions that use the PC value can be used normally in a macro block called by a BLM instruction, but the macro block should not include any instructions which modify the LR value.

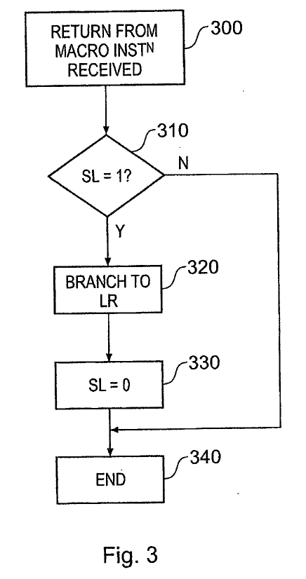

As can be seen in FIG. 4, the BLM instruction works very well where the block of instructions branched to by the BLM instruction ends in a procedure call instruction (in the example of FIG. 4, the BL instruction). However, by itself, the BLM instruction cannot readily replicate the functionality of the earlier-described EMB instruction for macro blocks that do not end in a procedure call instruction. However, in accordance with one embodiment of the present invention, a further instruction is provided, which will be referred to herein as a “Return from Macro” (RFM) instruction, that when placed at the end of a macro block not ending in a procedure call instruction, does enable the BLM instruction to replicate the function of the earlier-described EMB instruction. The function of the RFM instruction is illustrated schematically in FIG. 3.

As can be seen from FIG. 3, when an RFM instruction is received by the prefetch unit at step 300, it is determined at step 310 whether the SL bit is set. If it is not set, then the process proceeds directly to step 340, where handling of the RFM instruction terminates. Accordingly, it can be seen that if the SL bit is not set, then the RFM instruction performs no operation.

However, if the SL bit is set, then at step 320 the processor 10 performs a branch instruction to the address stored in the link register and at step 330 the SL bit is cleared. It will be appreciated that the order in which steps 320 and 330 are performed can be varied dependent on the implementation. Thereafter, at step 340, the process ends.

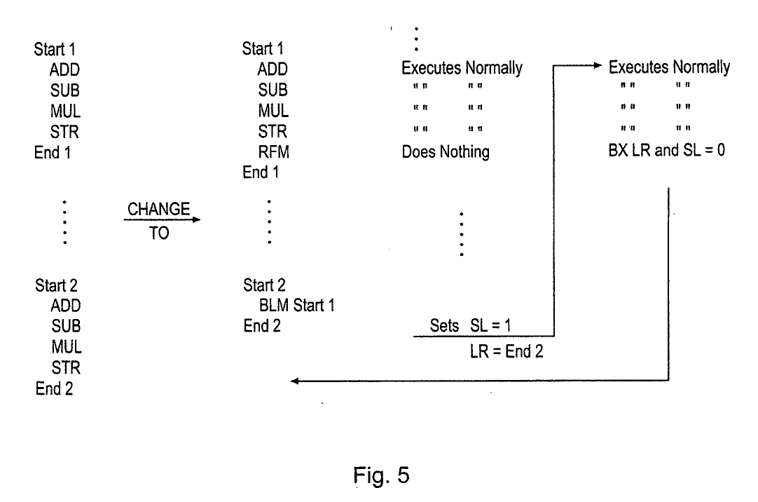

The manner in which this RFM instruction can be used in one embodiment of the present invention is illustrated schematically in FIG. 5. In FIG. 5, it is assumed that the four instructions appearing in the upper half of the left hand side of FIG. 5 are identical to the four instructions appearing in the lower half of the left hand side of FIG. 5, and in particular each corresponding instruction in each half of FIG. 5 uses the exactly the same source and destination operands. The way in which the BLM and RFM instructions can be used to reduce the code size of such a sequence of instructions is illustrated in the middle part of FIG. 5. As can be seen from FIG. 5, the lower sequence of four instructions is replaced by a BLM instruction specifying as a target address the location “start 1”, and at the end of the upper four instructions, an RFM instruction is added.

Execution of this revised sequence of instructions is shown schematically in FIG. 5. As can be seen, the add, subtract, multiply and store instructions execute normally on the first pass, and when the RFM instruction is first encountered, it causes no operation to be performed. This is because, with reference to FIG. 3, the SL bit is clear the first time this RFM instruction is encountered, and accordingly the process proceeds from step 310 directly to step 340.

When the BLM instruction is subsequently encountered, this causes the SL bit to be set, and the return address value to be generated, causing the link register to be updated to refer to the location “end 2”. The instruction flow then branches to the location “start 1”, and again the add, subtract, multiply and store instructions execute normally. When the RFM instruction is then executed for the second time, since the SL bit is now set, this causes the process to execute a branch instruction to branch to the address shown in the link register, i.e. the location “end 2”, and also causes the SL bit to be cleared, as discussed previously with reference to steps 320 and 330 of FIG. 3. Accordingly, it can be seen that in this scenario the original sequence of eight instructions are reduced to six instructions, again giving a significant code density improvement. Hence, the functionality of the earlier-described EMB instruction is achieved using the much simpler BLM instruction, this time in combination with an RFM instruction to enable the required functionality to be performed on the second iteration through the macro block of instructions.

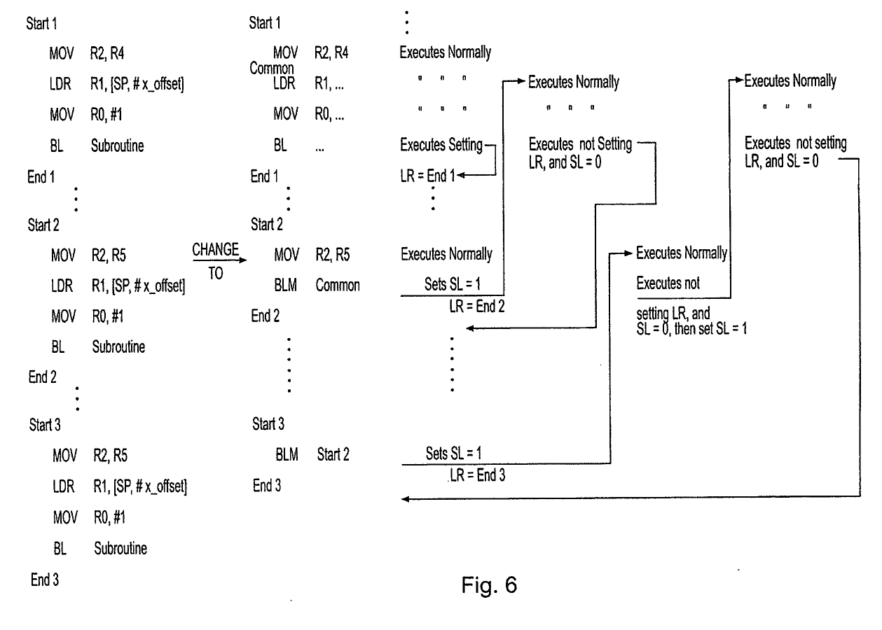

Since the BLM instruction has been defined to operate like a procedure call instruction, but with the additional functionality of setting the SL bit, it is also possible to “chain” BLM instructions, such that for example a macro block identified by one BLM instruction can end with another BLM instruction. This is illustrated schematically in FIG. 6. In the left hand side of FIG. 6, an original sequence of instructions is shown. As can be seen, the LDR, MOV and BL macro block of instructions is repeated three times within the sequence of program instructions. Further, it should be noted that the four instructions appearing between the locations “start 2” and “end 2” are also repeated between the positions “start 3” and “end 3”.

The manner in which the BLM instructions are used to reduce the code size of this sequence of instructions is illustrated in the middle column of FIG. 6. In particular, it can be seen that the last three instructions appearing between the locations “start 2” and “end 2” are replaced by a BLM instruction, and the four instructions appearing between the locations “start 3” and “end 3” are replaced by a further BLM instruction. The manner in which this sequence of instructions are executed is shown schematically in the right hand half of FIG. 6. In particular, as shown, the first three instructions are executed normally, and then when the BL instruction is encountered, it also executes normally given that the SL bit is currently clear, and accordingly sets in the link register a return address value pointing to the location “end 1” and performs the necessary subroutine. When the subroutine ends, the process branches back to the instruction at the location “end 1”.

When execution reaches the point “start 2”, then the move instruction is executed normally, and execution of the following BLM instruction causes the link register value to be updated to the location “end 2” and the SL bit to be set. The process then branches to the location “Common”, whereafter the following load and move instructions are executed normally. When the BL instruction is then encountered for the second time, generation of the return address value is suppressed due to the SL bit being set, and instead the SL bit is cleared. The subroutine specified by the BL instruction is then performed, and on completion of the subroutine processing returns to the location specified in the link register, in this case the location “end 2” as set in the link register by the BLM instruction.

Processing then continues and when it reaches the location “start 3”, the second BLM instruction is executed. This again causes the SL bit to be set and the link register is now updated to refer to the location “end 3”. Processing then branches to the location “start 2”, where the move instruction at that location executes normally. Then the following BLM instruction is executed. With reference to FIG. 2, it can be seen that since the SL bit is already set, then the process proceeds via step 130 where the SL bit is cleared, and suppression of a return address occurs. However, because the procedure call instruction is a BLM instruction, then at step 150 the SL bit is again set. The process then branches to the location “common”, whereafter the load instruction at that location and the following move instruction are executed normally. When the BL instruction is then encountered for the third time, it again executes without generating a return address value, and the SL bit is set to zero. The subroutine is executed and on completion of the subroutine the execution flow returns to the address stored in the link register, which will be the location “end 3”. Accordingly, with reference to FIG. 6, it can be seen that through the use of the chained BLM instructions, eleven instructions are reduced to six instructions, thereby producing significant code density savings.

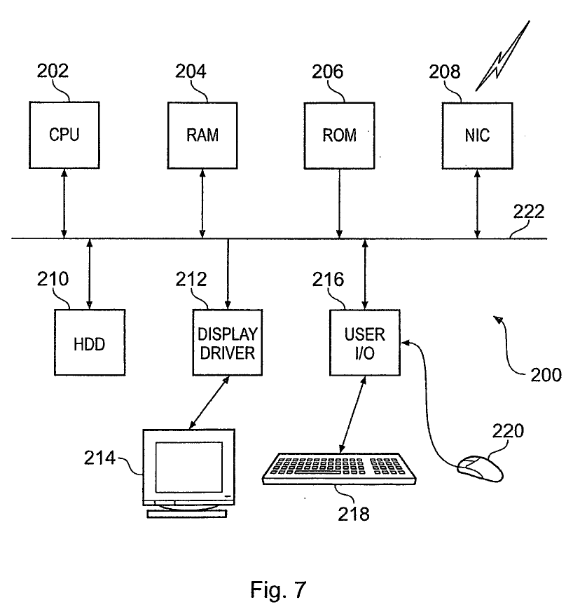

FIG. 7 schematically illustrates a general purpose computer 200 of the type that may be used to implement the above described techniques. The general purpose computer 200 includes a central processing unit 202, a random access memory 204, a read only memory 206, a network interface card 208, a hard disk drive 210, a display driver 212 and monitor 214 and a user input/output circuit 216 with a keyboard 218 and mouse 220 all connected via a common bus 222. In operation the central processing unit 202 will execute computer program instructions that may be stored in one or more of the random access memory 204, the read only memory 206 and the hard disk drive 210 or dynamically downloaded via the network interface card 208. The results of the processing performed may be displayed to a user via the display driver 212 and the monitor 214. User inputs for controlling the operation of the general purpose computer 200 may be received via the user input output circuit 216 from the keyboard 218 or the mouse 220. It will be appreciated that the computer program could be written in a variety of different computer languages. The computer program may be stored and distributed on a recording medium or dynamically downloaded to the general purpose computer 200. When operating under control of an appropriate computer program, the general purpose computer 200 can perform the above described techniques and can be considered to form an apparatus for performing the above described technique. The architecture of the general purpose computer 200 could vary considerably and FIG. 7 is only one example.

From the above description, it will be seen that the BLM instruction of preferred embodiments provides a mechanism for achieving significant code density improvements, whilst avoiding some of the complexities of the earlier-described EMB instruction. In particular, unlike the EMB instruction, the BLM instruction of the preferred embodiments only requires the addition of a single bit to the CPSR register bits, and generates comparatively few architectural corner cases. Further, BLM instructions can be “chained” together to enable even further significant code density savings to be achieved.

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

1. A data processing apparatus, comprising:
processing logic operable to perform data processing operations specified by program instructions fetched from a sequence of addresses, at least one of the program instructions being a procedure call instruction specifying a branch operation to be performed;
control storage operable to store a control value;
the processing logic being operable in response to a control value modifying instruction to modify the control value;
if the control value is clear, the processing logic being operable in response to the procedure call instruction to generate a return address value in addition to performing the branch operation;
if the control value is set, the processing logic being operable in response to the procedure call instruction to suppress generation of the return address value and to cause the control value to be cleared in addition to performing the branch operation.

2. A data processing apparatus as claimed in claim 1, wherein the processing logic is further operable in response to the control value modifying instruction to generate a return address value.

3. A data processing apparatus as claimed in claim 2, wherein the control value modifying instruction is a procedure call instruction and hence further specifies a branch operation to be performed.

4. A data processing apparatus as claimed in claim 3, wherein the control value modifying instruction comprises an offset field specifying a target address for the branch operation relative to an address of the control value modifying instruction.

5. A data processing apparatus as claimed in claim 4, wherein the offset field specifies a negative offset value such that the target address is an address less than the address of the control value modifying instruction.

6. A data processing apparatus as claimed in claim 1, wherein the processing logic comprises:
instruction fetching logic operable to fetch the program instructions from the sequence of addresses; instruction decode logic responsive to the program instructions fetched by said instruction fetching logic to control the data processing operations specified by said program instructions; and
execution logic operable under control of said instruction decode logic to execute said data processing operations.

7. A data processing apparatus as claimed in claim 6, wherein the instruction fetching logic is operable, upon fetching a control value modifying instruction, to modify the control value.

8. A data processing apparatus as claimed in claim 6, wherein, if the control value is set prior to handling of the procedure call instruction by the processing logic, the instruction decode logic is operable in response to the procedure call instruction to suppress generation of the return address value.

9. A data processing apparatus as claimed in claim 6, wherein, if the control value is set prior to handling of the procedure call instruction by the processing logic, the instruction fetching logic is operable in response to the procedure call instruction to cause the control value to be cleared.

10. A data processing apparatus as claimed in claim 1, wherein:
if the control value is clear, the processing logic is operable in response to a selective return instruction to perform no operation;
if the control value is set, the processing logic is operable in response to the selective return instruction to perform a return operation to branch to an instruction at the return address value and to cause the control value to be cleared.

11. A method of operating a data processing apparatus having processing logic for performing data processing operations specified by program instructions fetched from a sequence of addresses, at least one of the program instructions being a procedure call instruction specifying a branch operation to be performed, the method comprising using the processing logic to perform the steps of:
storing a control value;
in response to a control value modifying instruction, modifying the control value;
if the control value is clear, in response to the procedure call instruction, generating a return address value in addition to performing the branch operation; and
if the control value is set, in response to the procedure call instruction, suppressing generation of the return address value and causing the control value to be cleared in addition to performing the branch operation.

12. A computer program product comprising a computer program operable when executed on a data processing apparatus to cause the data processing apparatus to operate in accordance with the method of claim 11, the computer program comprising at least one procedure call instruction and at least one control value modifying instruction.
